(19) United States
(12) Patent Application Publication
(10) Pub. No.: US 2016/0106614 A1
(43) Pub. Date: Apr. 21, 2016

(54) REVOLVING CHAIR FOR MEDICAL EXAMINATION AND TREATMENT

(71) Applicant: Sang Sik KIM, Seoul (KR)

(72) Inventor: Sang Sik KIM, Seoul (KR)

(21) Appl. No.: 14/892,909

(22) PCT Filed: May 30, 2013
(86) PCT No.: PCT/KR2013/004771

§ 371 Date: Nov. 20, 2015

(51) Int. Cl. A61H 1/00; A61G 5/10; A61G 5/04

(52) U.S. Cl. CPC A61H 1/001; A61G 5/04; A61G 5/1056; A61H 2201/1215; A61H 2203/0431

(57) ABSTRACT

A revolving chair for medical examination and treatment includes: a revolving loop unit including at least one revolving loop which is provided to be rotatable about a first revolving axis; a roller which is disposed to contact the revolving loop and is formed to revolve the revolving loop by revolution thereof; a first driving motor which is connected to the roller to revolve the roller such that the revolving loop unit can revolve about the first revolving axis; a chair unit which is connected to the revolving loop unit so as to revolve together with the revolving loop unit and is provided to be rotatable about a second revolving axis; and a second driving motor which is connected to the chair unit to revolve the chair unit such that the chair unit can revolve about the second revolving axis.

### TECHNICAL FIELD

The present invention relates to a revolving chair which can be used in medical examination and treatment.

### BACKGROUND ART

A revolving chair is used for a medical examination and treatment such as dizziness test and treatment. Such a revolving chair is provided with a seat on which a user may sit, and the seat is configured to be rotatable.

Various structures for revolving the revolving chair have been introduced. For example, there is a revolving chair in which a chair is formed to be revolved manually, and there is also a method of revolving the chair using a motor.

In a case of a structure in which a chair is revolved by a motor, a motor is disposed at a rear center portion of a revolving body to which a chair is mounted, and a rotating shaft of a motor is connected to the revolving body so as to revolve the revolving body.

However, in such a method, the distance between the motor and the revolving body is great so that great inertia is generated, so it is difficult to realize a precise revolution control and there is a limitation in increasing the revolving speed.

### DETAILED DESCRIPTION OF THE INVENTION

### Technical Problem

The present invention has been made in an effort to provide a revolving chair for a medical examination and treatment in which the revolving body can be stably supported and inertia between a motor and a revolving body can be decreased so that a precise revolution control is possible and a revolution speed can be increased.

### Technical Solution

A revolving chair for medical examination and treatment according to an embodiment of the present invention includes: a revolving loop unit including at least one revolving loop which is provided to be rotatable about a first revolving axis; a roller which is disposed to contact the revolving loop and is formed to revolve the revolving loop by revolution thereof; a first driving motor which is connected to the roller to revolve the roller such that the revolving loop unit can revolve about the first revolving axis; a chair unit which is connected to the revolving loop unit so as to revolve together with the revolving loop unit and is provided to be rotatable about a second revolving axis; and a second driving motor which is connected to the chair unit to revolve the chair unit such that the chair unit can revolve about the second revolving axis.

The revolving loop unit may include a plurality of revolving loops which are disposed in a forward/backward direction and a connecting bar connecting the plurality of revolving loops, and the roller may include a plurality of rollers which respectively supports the plurality of revolving loops.

The plurality of rollers may be disposed in a direction parallel to a direction in which the plurality of revolving loops are disposed and rotatably support the plurality of revolving loops respectively in a state of circumscribing with the plurality of revolving loops, and the plurality of rollers may be connected to the first driving motor so as to be revolved by the first driving motor.

The revolving chair may further include support plates which are provided to a support body which supports the rollers and respectively support outer surfaces of the revolving loops in a direction in which the plurality of revolving loops are disposed.

The roller may include a plurality of rollers which are disposed below the revolving loops at the sides thereof and rotatably supports the revolving loops respectively.

The revolving chair may further include a position restricting roller which supports a side surface of the revolving loop.

The chair unit may include a seat on which a user can sit, wherein the revolving loop is provided in a plural, and wherein the seat is disposed within a space which is formed by the plurality of the revolving loops.

### Advantageous Effects

According to the present invention, since the driving motor directly drives the roller revolving the revolving loop, inertia of the revolving loop can be decreased so that a precise revolution control is possible and the revolution speed can be increased.

### BRIEF DESCRIPTION OF DRAWINGS

FIG. 1 is a perspective view of a revolving chair for medical examination and treatment according to an embodiment of the present invention.

FIG. 2 is a front view of a revolving chair for medical examination and treatment according to an embodiment of the present invention.

FIG. 3 is a side view of a revolving chair for medical examination and treatment according to an embodiment of the present invention

### DETAILED DESCRIPTION OF THE EMBODIMENTS

An embodiment of the present invention will be described in detail with reference to the accompanying drawings.

A revolving chair for medical examination and treatment according to an embodiment of the present invention can be used for medical examination and treatment such as examination and treatment of dizziness or the like.

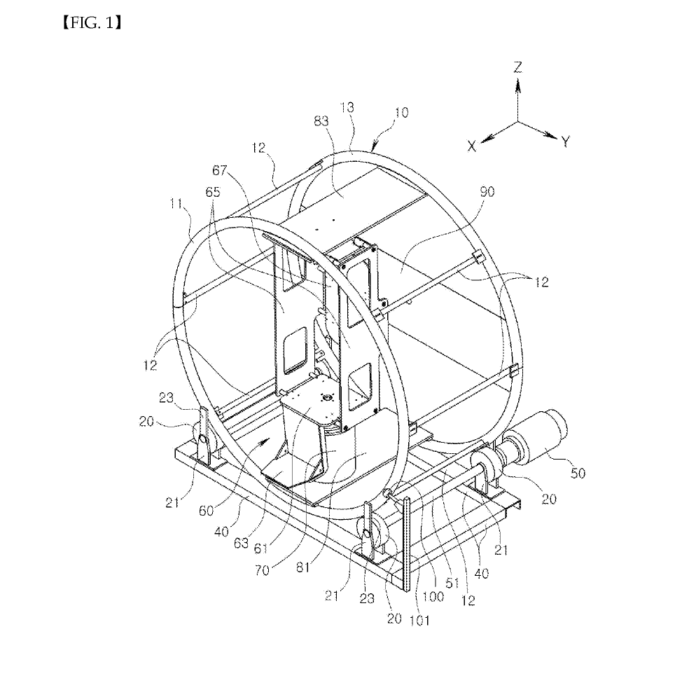

Referring to FIG. 1 to FIG. 3, a revolving chair for medical examination and treatment according to an embodiment of the present invention includes a revolving loop unit 10.

The revolving unit 10 includes revolving loops 11 and 13 which are provided to be able to revolve. Two revolving loops 11 and 13 are shown in the drawings, but the number of the revolving loops 11 and 13 is not limited thereto.

The revolving loops 11 and 13 may have a circular ring shape and may be made of metal which has a high strength. The two revolving loops 11 and 13 may be disposed to be parallel with one another along a forward/backward direction, i.e., a direction of X axis in the drawings, and the two revolving loops 11 and 13 may be connected to one another by connecting bars 12 so as to revolve together.

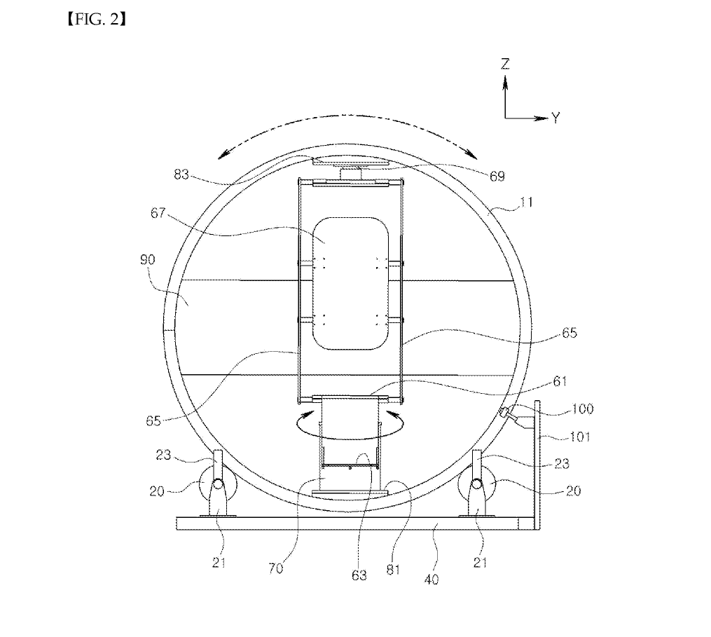

The revolving loops 11 and 13 is provided to be able to revolve about a first revolving axis. At this time, the first revolving axis is an axis passing through the center of the revolving loops 11 and 13 and may be an axis parallel with X axis in the drawing. Since the revolving loops 11 and 13 can revolve about the first revolving axis, the outer circumferential surface of the revolving loops 11 and 13 can revolve in both directions of dotted arrows in FIG. 2.

Rollers 20 contacts the revolving loops 11 and 13 so as to revolve the revolving loops 11 and 13. For example, as shown in the drawings, two rollers 20 are provided to the respective revolving loops 11 and 13, i.e., four rollers 20 may support the revolving loops 11 and 13 to be able to revolve. When the rollers 20 revolves, the revolving loops 11 and 13 which are disposed to contact may also revolve in the direction of the arrow shown in FIG. 2.

Since the rollers 20 revolves the revolving loops 11 and 13 by the revolving thereof, the rollers 20 may be made of material having relatively high friction such as rubber.

For example, the rollers 20 are arranged in a direction in which the plurality of revolving loops 11 and 13 are arranged, i.e., in a direction parallel to the X-axis in the drawing to rotatably support the revolving loops 11 and 13 in a state of respectively circumscribing the revolving loops 11 and 13.

At this time, as shown in FIG. 1 to FIG. 3, the roller 20 may be rotatably connected to a supporting body 21, and the supporting body 21 may be fixed to a supporting frame 40.

As shown in the drawing, the revolving loops 11 and 13 are rotatably supported by the plurality of rollers 20 which are disposed below both sides thereof, the revolving loops 11 and 13 are stably disposed on four rollers 20.

A first driving motor 50 is connected to the roller 20 to revolve the roller 20. For example, the center portion of the roller 20 may be connected to an output shaft of the first driving motor 50. Since the first driving motor 50 revolves the roller 20, the revolving loop unit 10 can revolve about a first revolving axis which is parallel to the X-axis.

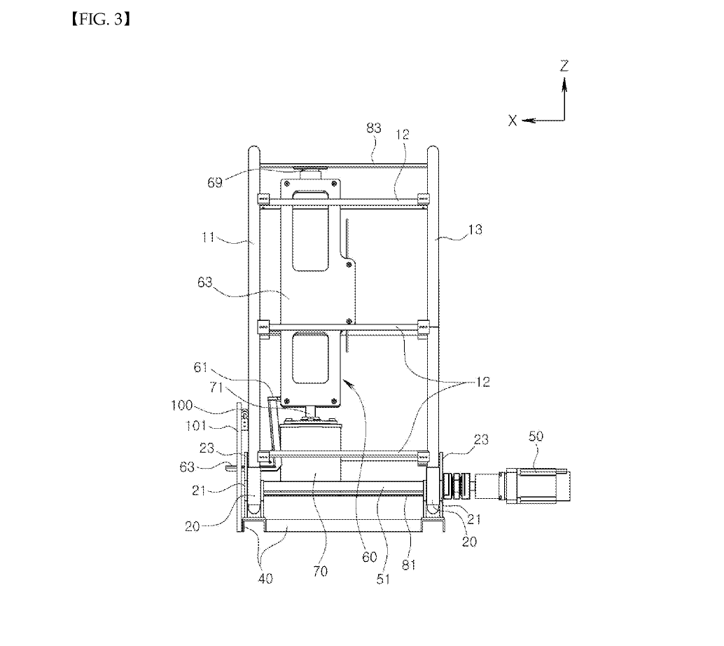

At this time, the rollers 20 which respectively support the revolving loops 11 and 13 may be respectively connected to the first driving motor 50. For example, as shown in FIG. 1 and FIG. 3, the two rollers 20 respectively supporting the revolving loops 11 and 13 are connected to one another via a connecting bar 51 so as to revolve together, and the connecting bar 51 is connected to an output shaft of the first driving motor 50, so that the two rollers 20 can be driven to revolve by the first driving motor 50. As such, since the rollers 20 revolving the respective revolving loops 11 and 13 revolve respectively by the first driving motor 50, the revolving loops 11 and 13 can be supported to revolve more stably.

A chair unit 60 is mounted to the revolving loop unit 10 so as to revolve with the revolving loop unit 10. Also, the chair unit 60 is provided to be rotatable about a second revolving axis. Referring to FIG. 3, the second revolving axis may be an axis parallel to a Z axis. Accordingly, the chair unit 60 may revolve together with the revolving loop unit 10 and can additionally revolve about the second revolving axis.

The chair unit 60 may be provided with a seat 61 which is formed such that a user having a medical examination or treatment can seat thereon, and a foot rest 63 on which a user puts his feet may be provided therebelow.

As shown in the drawings, the seat 61 may be disposed within a space which is formed by the two revolving loops 11 and 13. Accordingly, since almost all portion of a body of a person sitting on the seat 61 to have a medical examination or treatment can be disposed within the space which is formed by the revolving loops 11 and 13, an accident which may occur during the medical examination or treatment can be prevented.

Further, a pair of side walls 65, which forms a space in which an upper body of a user is disposed, are disposed to face one another at both sides of the seat, and the side walls 65 are respectively extended from an upper surface of the seat 61 in an upper direction so as to have a plate shape. A backrest 67 may be provided above the seat 61, and the backrest 67 may be fixed to the side walls 65.

A second driving motor 70 for revolving the chair unit 60 is provided. The second driving motor 70 is connected to the chair unit 60 to revolve the char unit 60 such that the chair unit 60 can revolve about the second revolving axis.

For example, the chair unit 60 and the second driving motor 70 may be disposed between two mounting plates 81 and 83 which are connected to the revolving loops 11 and 13. As shown in the drawing, the two mounting plates 81 and 83 are fixed to the revolving loops 11 and 13 in a state of being apart from one another, and the second driving motor 70 may be fixed onto the lower mounting plate 81, and a lower part of the chair unit 60 is connected to an output shaft 71 of the second driving motor 70 and an upper part thereof is rotatably connected to the upper mounting plate 183 via a rotating shaft 69. According to these connections, the chair unit 60 can revolve about the second revolving axis by the operation of the second driving motor 70.

Meanwhile, support plates 23 which are provided to the support body 21 and respectively support outer surfaces of the revolving loops in a direction (X axis direction in the drawing) of the plurality of revolving loops 1 and 13 are disposed may be provided. That is, as shown in FIG. 3, since a front surface of the front revolving loop 11 and a rear surface of the rear revolving loop 13 are respectively supported by the support plates 23, the revolving loop unit 10 can stably revolve at a determined position.

Meanwhile, a position restricting roller 100 which supports side of the revolving loops 11 and 13 may be provided. The position restricting roller 100 may be provided to a support member 101 which is connected to the support frame 40, and the position restricting roller 100 may be disposed to contact the outer surface of the revolving loops 11 and 13. Although the position restricting roller 100 supports the front surface of the front revolving loop 11 in the drawing, the position restricting roller may be disposed to support the rear surface of the rear revolving loop 13, and it is also possible that two position restricting rollers 100 are provided to respectively support the front surface of the front revolving loop 11 and the rear surface of the rear revolving loop 13. The revolving loops 11 and 13 can revolve while maintaining a position in an X axis by the position restricting rollers 100.

Meanwhile, not shown in the drawings, a connecting device for connecting a cable for supplying electrical power and various signals may be provided, and this connecting device may be fixed to a mounting plate 90 which is fixed to the rear revolving loop 13.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention may be applied to a medical examination and treatment, so the present invention has an industrial applicability.

1. A revolving chair for medical examination and treatment comprising:
a revolving loop unit including at least one revolving loop which is provided to be rotatable about a first revolving axis;
a roller which is disposed to contact the revolving loop and is formed to revolve the revolving loop by revolution thereof;
a first driving motor which is connected to the roller to revolve the roller such that the revolving loop unit can revolve about the first revolving axis;
a chair unit which is connected to the revolving loop unit so as to revolve together with the revolving loop unit and is provided to be rotatable about a second revolving axis; and
a second driving motor which is connected to the chair unit to revolve the chair unit such that the chair unit can revolve about the second revolving axis.

2. The revolving chair of claim 1, wherein the revolving loop unit comprises a plurality of revolving loops which are disposed in a forward/backward direction and a connecting bar connecting the plurality of revolving loops, and
wherein the roller comprises a plurality of rollers which respectively supports the plurality of revolving loops.

3. The revolving chair of claim 2, wherein the plurality of rollers are disposed in a direction parallel to a direction in which the plurality of revolving loops are disposed and rotatably support the plurality of revolving loops respectively in a state of circumscribing with the plurality of revolving loops, and wherein the plurality of rollers are connected to the first driving motor so as to be revolved by the first driving motor.

4. The revolving chair of claim 3, further comprising support plates which are provided to a support body which supports the rollers and respectively support outer surfaces of the revolving loops in a direction in which the plurality of revolving loops are disposed.

5. The revolving chair of claim 1, wherein the roller comprises a plurality of rollers which are disposed below the revolving loops at the sides thereof and rotatably supports the revolving loops respectively.

6. The revolving chair of claim 1, further comprising a position restricting roller which supports a side surface of the revolving loop.

7. The revolving chair of claim 1, wherein the chair unit comprises a seat on which a user can sit, wherein the revolving loop is provided in a plural, and wherein the seat is disposed within a space which is formed by the plurality of the revolving loops.
